(19) United States
(12) Patent Application Publication
(10) Pub. No.: US 2025/0183519 A1
(43) Pub. Date: Jun. 5, 2025

(54) TERMINAL ANTENNA AND ELECTRONIC DEVICE

(71) Applicant: Honor Device Co., Ltd., Shenzhen (CN)

(72) Inventors: Yuanpeng LI, Shenzhen (CN); Dawei ZHOU, Shenzhen (CN); Ruoqing ZHU, Shenzhen (CN)

(73) Assignee: Honor Device Co., Ltd., Shenzhen (CN)

(21) Appl. No.: 18/843,038

(22) PCT Filed: Aug. 12, 2022
(86) PCT No.: PCT/CN2022/137643

§ 371 Date: Aug. 30, 2024

(30) Foreign Application Priority Data
Apr. 1, 2022 (CN) 202210340006.8

(51) Int. Cl. H01Q 1/24; H01Q 9/04

(52) U.S. Cl. CPC H01Q 1/243; H01Q 9/0421; H01Q 9/045

(57) ABSTRACT

Embodiments of this application relate to the field of antenna technologies, and disclose a terminal antenna and an electronic device, which can provide good radiation performance in a poor environment. The terminal antenna includes a first radiator, the first radiator is provided with a first feed and a first ground point, and the first ground point is arranged at an end of the first radiator. The first ground point is connected to the first radiator through a first inductor, and a value of the first inductor is included within a range of [5 nH, 47 nH].

This application claims priority to Chinese Patent Application No. 202210340006.8, filed with the China National Intellectual Property Administration on Apr. 1, 2022 and entitled “TERMINAL ANTENNA AND ELECTRONIC DEVICE”, which is incorporated herein by reference in its entirety.

### TECHNICAL FIELD

This application relates to the field of antenna technologies, and in particular, to a terminal antenna and an electronic device.

### BACKGROUND

With development of electronic devices, an environment that can be provided for an antenna in the electronic devices is increasingly poor. To ensure a wireless communication function of the electronic devices (such as mobile phones), an antenna solution that can provide good radiation performance in a poor environment is required.

### SUMMARY

Embodiments of this application provide a terminal antenna and an electronic device, which can provide good radiation performance in a poor environment. The terminal antenna provided in this application is used in a low-frequency operation scenario.

To achieve the foregoing objective, the following technical solutions are used in embodiments of this application:

According to a first aspect, a terminal antenna is provided. The terminal antenna is arranged in an electronic device, the terminal antenna includes a first radiator, the first radiator is provided with a first feed and a first ground point, and the first ground point is arranged at an end of the first radiator. The first ground point is connected to the first radiator through a first inductor, and a value of the first inductor is included within a range of [5 nH, 47 nH]. Based on this solution, an end of the radiator away from the feed is grounded through the inductor, so that an electric field between the radiator and a reference ground can be adjusted, to obtain a uniformly distributed electric field for radiation, thereby providing good radiation performance in a limited space.

In a possible design, a second inductor is arranged between the first feed and the first radiator, one end of the second inductor is connected to the first feed and the first radiator, the other end of the second inductor is grounded, and the second inductor is less than 5 nH. The first inductor and/or the second inductor are/is configured to adjust a resonance frequency of the terminal antenna. Based on this solution, the second inductor is arranged at the feed, so that an operating frequency band of the entire antenna can be effectively adjusted through tuning of the second inductor and the first inductor.

In a possible design, the first radiator is arranged in an L-shaped structure at any corner of the electronic device. The L-shaped structure includes a first arm and a second arm, and the first arm is perpendicular to the second arm. The first feed is arranged on the first arm, and the first ground point is arranged on the second arm. Based on this solution, a specific implementation of how the radiator is arranged and where the feed and the ground point are arranged is provided. Through arrangement at a corner of the electronic device, the antenna can match an electric field distribution eigenmode of the electronic device, to excite a floor well for radiation, thereby improving radiation performance of the antenna.

In a possible design, a straight line on which the first arm is located is parallel to a long edge of the electronic device. Based on this solution, an example of where the feed is arranged is provided. In this way, when the feed excites the antenna, an oblique current and a longitudinal current can be excited on the floor, so that a transverse current and the longitudinal current are balanced well, to improve radiation performance of the antenna.

In a possible design, a distance from the first feed to the second arm is included within a range of [0 mm, 30 mm]. Based on this solution, an example of where the feed is arranged is provided.

In a possible design, when the terminal antenna operates, a uniform electric field is distributed between the first radiator and a reference ground. A current reversal point is distributed on a first part of the first radiator. The first part is a radiator that is on the first radiator and that is between the first feed and the first ground point. Based on this solution, a limitation on a current distribution characteristic during operation of the antenna is provided. It may be understood that, for a general ¼ wavelength mode, left-hand mode, or the like, current distribution between the feed and the ground point is not reversed.

In a possible design, a length of the first part is greater than ⅛ of a wavelength of an operating frequency band and less than ¼ of the wavelength of the operating frequency band, and the operating frequency band is an operating frequency band of the terminal antenna. Based on this solution, a limitation on a length of the radiator is provided. Compared with the ¼ wavelength mode, this achieves a miniaturized design.

In a possible design, the first radiator further includes a second part, the second part is connected to the first part at the first feed, and an end of the second part away from the first feed is suspended. Based on this solution, an example of an extended antenna solution is provided. In this way, the second part can excite an additional resonance to expand a bandwidth.

In a possible design, a length of the second part is included within a range of [30 mm, 40 mm]. When the terminal antenna operates, the ¼ wavelength mode is excited on the second part, and a direction of an electric field between the second part and the reference ground is the same as a direction of an electric field between the first arm of the first part and the reference ground. Based on this solution, a specific limitation on expansion of a main resonance during operation of the second part is provided. For example, expansion may be performed in a high-frequency direction of the main resonance (that is, a resonance covering the operating frequency band), to improve radiation performance.

In a possible design, the terminal antenna further includes a second radiator, the second radiator is not connected to the first radiator, and an end of the second radiator is arranged opposite to the end of the first radiator at which the first ground point is arranged. The second radiator is provided with a second ground point, the second ground point is arranged at an end of the second radiator close to the first radiator, and the other end of the second radiator is arranged suspended. Based on this solution, an example of another extended antenna solution is provided. In this way, the second radiator can excite an additional resonance to expand a bandwidth.

In a possible design, a length of the second radiator is included within a range of [13 mm, 20 mm]. When the terminal antenna operates, a resonance frequency of a parasitic mode excited on the second radiator is lower than the operating frequency band of the terminal antenna. Based on this solution, a specific limitation on expansion of a main resonance during operation of the second radiator is provided. For example, expansion may be performed in a low-frequency direction of the main resonance (that is, a resonance covering the operating frequency band), to improve radiation performance.

In a possible design, the second radiator is arranged on an outer side of a USB interface of the electronic device, and the second radiator is not connected to a body of the USB interface. Based on this solution, a specific limitation on arrangement of the second radiator is provided. For example, the second radiator may be arranged on a USB appearance surface. In order that the second radiator and the USB do not affect each other and an effective parasitic effect can be achieved, the second radiator may be not connected to the body (that is, a metal part) of the USB interface.

In a possible design, the first feed is configured to feed a low-frequency signal to the first radiator, and a frequency of the low-frequency signal is included within a range of [500 MHz, 960 MHz]. Based on this solution, a specific application scenario of the terminal antenna is provided, such as covering a low frequency band in a split-feed solution.

According to a second aspect, a split-feed antenna system is provided. The split-feed antenna system includes a first antenna and a second antenna. The first antenna is the terminal antenna provided in the first aspect and any possible design thereof. The second antenna includes a third radiator, the third radiator is arranged in an L shape at a corner of the electronic device, a corner at which the third radiator is located is adjacent to the corner at which the first antenna is located. The third radiator is not connected to the radiator of the first antenna, and an end of the third radiator is coupled to an end of the radiator of the first antenna through a gap. The third radiator is provided with a second feed, the second feed is configured to feed an intermediate/high-frequency signal to the second antenna, and a frequency of the intermediate/high-frequency signal is included within a range of [1400 MHZ, 2700 MHz]. Based on this solution, an example of a split-feed antenna solution is provided. In this example, a low frequency band is covered by the terminal antenna provided in the first aspect, and an intermediate/high frequency part is covered by the second antenna. Therefore, in the low frequency band, good radiation performance can be obtained in a limited space. In addition, the radiator corresponding to the low frequency band may generate a multiplied-frequency resonance during intermediate/high-frequency coverage. Therefore, the intermediate/high frequency part in the split-feed antenna solution can also have good radiation performance.

In a possible design, the third radiator is further provided with a third ground point, and the third ground point and the second feed are arranged on two arms of an L-shaped structure corresponding to the third radiator. Based on this solution, an example of how to arrange the ground point and the feed point on the third radiator is provided.

According to a third aspect, an electronic device is provided. The electronic device is provided with the terminal antenna provided in the first aspect and any possible design thereof. When the electronic device transmits or receives a low-frequency signal, the low-frequency signal is transmitted or received through the terminal antenna.

It should be understood that the technical solution of the third aspect can correspond to the first aspect and any possible design thereof. Therefore, the beneficial effects that can be achieved are similar, and details are not described herein again.

According to a fourth aspect, an electronic device is provided. The electronic device is provided with the split-feed antenna system provided in the second aspect and any possible design thereof. When the electronic device transmits or receives a signal, the signal is transmitted or received through the split-feed antenna system.

It should be understood that the technical solution of the fourth aspect can correspond to the technical solution provided in the second aspect and any possible design thereof. Therefore, the beneficial effects that can be achieved are similar, and details are not described herein again.

### BRIEF DESCRIPTION OF DRAWINGS

FIG. 1 is a diagram of an electronic device;

FIG. 2 is a diagram of an antenna solution;

FIG. 3 is a diagram of electrical parameter distribution of an antenna solution;

FIG. 4 is a composition diagram of an electronic device according to an embodiment of this application;

FIG. 5 is an implementation diagram of a bezel antenna according to an embodiment of this application;

FIG. 6 is a composition diagram of a terminal antenna according to an embodiment of this application;

FIG. 7 is a diagram of electrical parameter distribution of a terminal antenna according to an embodiment of this application;

FIG. 8 is a diagram of electric field simulation of a terminal antenna according to an embodiment of this application;

FIG. 9 is a diagram of floor eigenmode distribution;

FIG. 10A is a diagram of comparison between floor current excitation under different feed arrangements according to an embodiment of this application;

FIG. 10B is a composition diagram of another terminal antenna according to an embodiment of this application;

FIG. 10C is a composition diagram of another terminal antenna according to an embodiment of this application;

FIG. 11 is a composition diagram of another terminal antenna according to an embodiment of this application;

FIG. 12 is a diagram of electrical parameter distribution of a terminal antenna according to an embodiment of this application;

FIG. 13 is a composition diagram of another terminal antenna according to an embodiment of this application;

FIG. 14 is a diagram of radiation efficiency simulation of a terminal antenna according to an embodiment of this application;

FIG. 15 is a diagram of system efficiency simulation of a terminal antenna according to an embodiment of this application;

FIG. 16 is a diagram of return loss simulation of hand phantoms of a terminal antenna in a frequency band B8 according to an embodiment of this application;

FIG. 17 is a diagram of radiation efficiency simulation of hand phantoms of a terminal antenna in a frequency band B8 according to an embodiment of this application;

FIG. 18 is a diagram of system efficiency simulation of hand phantoms of a terminal antenna in a frequency band B8 according to an embodiment of this application;

FIG. 19 is a diagram of return loss simulation of hand phantoms of a terminal antenna in a frequency band B5 according to an embodiment of this application;

FIG. 20 is a diagram of radiation efficiency simulation of hand phantoms of a terminal antenna in a frequency band B5 according to an embodiment of this application;

FIG. 21 is a diagram of system efficiency simulation of hand phantoms of a terminal antenna in a frequency band B5 according to an embodiment of this application;

FIG. 22 is a diagram of return loss simulation of head-and-hand phantoms of a terminal antenna in a frequency band B5 according to an embodiment of this application;

FIG. 23 is a diagram of radiation efficiency simulation of head-and-hand phantoms of a terminal antenna in a frequency band B5 according to an embodiment of this application;

FIG. 24 is a diagram of system efficiency simulation of head-and-hand phantoms of a terminal antenna in a frequency band B5 according to an embodiment of this application;

FIG. 25 is a composition diagram of a split-feed antenna solution according to an embodiment of this application; and

FIG. 26 is a composition diagram of another split-feed antenna solution according to an embodiment of this application.

### DESCRIPTION OF EMBODIMENTS

An electronic device may be provided with at least one antenna, to support a wireless communication function of the electronic device.

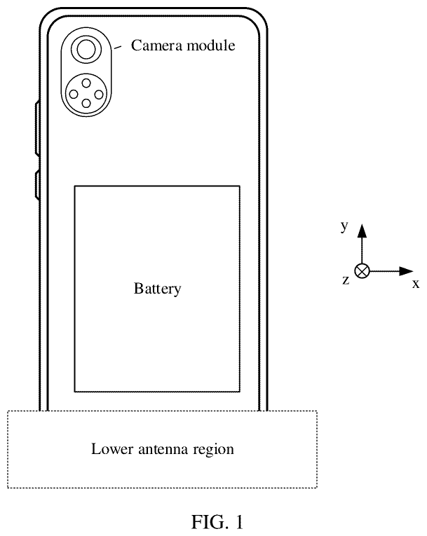

For example, the electronic device is a mobile phone. FIG. 1 is a rear view of the electronic device. In the rear view, a camera module arranged on an upper back part of the mobile phone can be seen. In a lower half part of the mobile phone, a component such as a battery may be arranged. In some implementations, an antenna for primary frequency communication in the mobile phone may be arranged in a lower antenna region shown in FIG. 1. The primary frequency may include frequency bands such as 500 MHz to 960 MHz and 1400 MHz to 2700 MHz. The 500 MHz to 960 MHz may also be referred to as a low frequency part of the primary frequency, or referred to as a low frequency band or a low frequency for short. Based on common frequency band division, the low frequency may further include frequency bands such as B28 (that is, 703 MHz to 803 MHZ), B5 (that is, 824 MHz to 894 MHz), and B8 (that is, 880 MHz to 960 MHz).

An antenna arranged in the electronic device to cover the primary frequency may be referred to as a primary frequency antenna. In a specific implementation of the primary frequency antenna, one feed may be used to excite a full frequency band of the primary frequency, or a plurality of feeds may be used to excite the low frequency and an intermediate/high frequency (for example, an intermediate frequency corresponding to 1400 MHz to 2170 MHz, and a high frequency corresponding to 2300 MHz to 2700 MHZ) respectively. A specific implementation form may be flexibly selected based on a structural environment provided for the antenna in the electronic device.

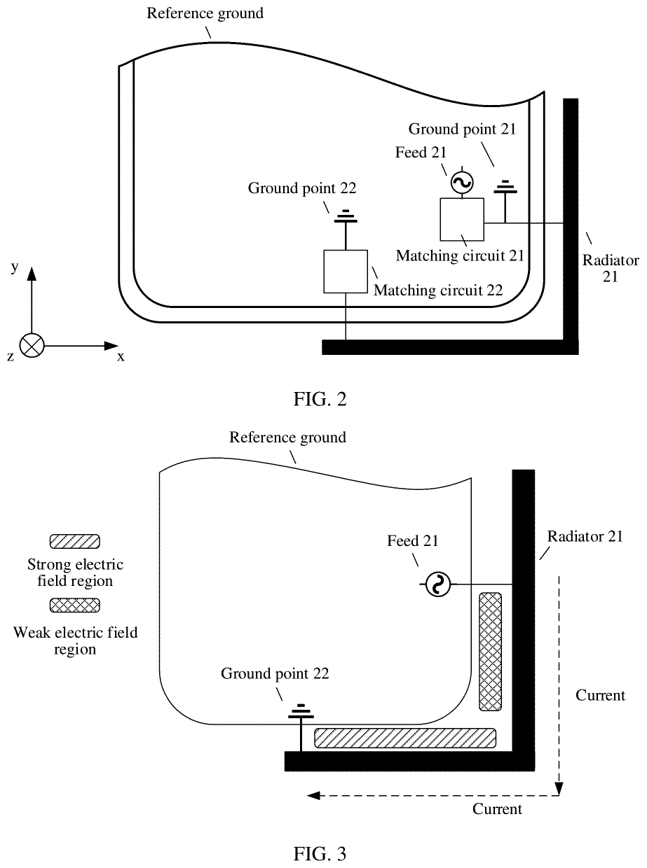

For example, a plurality of feeds are used to excite the low frequency and the intermediate/high frequency respectively. The solution in which the primary frequency is excited by a plurality of feeds may also be referred to as a split-feed solution. FIG. 2 is a diagram of an antenna solution for implementing low-frequency coverage in the split-feed solution. As shown in FIG. 2, the antenna may include a radiator, such as a radiator 21. The radiator 21 may be provided with a feed 21 for low-frequency feeding of the antenna. In some implementations, the feed 21 may be connected to the radiator 21 through a matching circuit 21. The matching circuit 21 may be configured to adjust port matching for the antenna. In the example shown in FIG. 2, the matching circuit may be provided with one or more components such as an inductor. The one or more components may be arranged in parallel, and the parallel components may be grounded through a ground point 21. The radiator 21 may be further provided with a ground point 22. The ground point 22 may also be provided with a matching circuit, such as a matching circuit 22 shown in FIG. 2. In some implementations, the matching circuit 22 may include an inductor with an inductance value less than 5 nH, to adjust inductance between the radiator 21 and a reference ground, thereby tuning an operating frequency band covered by the antenna, to cover a low frequency band.

In the antenna solution shown in FIG. 2, the arrangement of the radiator 21, the feed 21, and the ground point 22 may be equivalent to an inverted-F antenna structure. In this way, a typical structure of an IFA antenna is formed. The antenna may cover the low frequency by exciting a ¼ wavelength mode. It should be understood that, in the ¼ wavelength mode, current distribution on the radiator 21 is in a same direction, that is, there is no current reversal point on the radiator 21. For example, at some moments, a part close to the feed 21 has a strong current point and a weak electric field. Correspondingly, a part away from the feed 21, for example, a part close to the ground point 22, has a weak current point and a strong electric field. Then, with reference to FIG. 3, when the antenna operates, a current direction on the radiator 21 may be a direction from the feed 21 to the ground point 22, where there is no current reversal point. Correspondingly, due to a difference in electric field distribution near the radiator, a strong electric field is distributed near the ground point 22, and a weak electric field is distributed near the feed 21.

Generally, when the typical IFA antenna covers the low frequency in the ¼ wavelength mode, radiation performance of the antenna is closely related to an environment surrounding the antenna. For example, when an antenna clearance is large, the antenna can provide good radiation performance at the low frequency. Correspondingly, when the antenna clearance is small, low-frequency radiation performance that the antenna can provide is significantly affected. The antenna clearance may be a distance between the antenna radiator and the reference ground. The clearance may vary at different positions of the antenna radiator. In addition, another component arranged between the antenna radiator and the reference ground and having a different dielectric constant from the antenna radiator may also affect the radiation performance of the antenna.

With development of the electronic device, more components need to be arranged in a limited space of the electronic device to provide more functions. Therefore, a clearance that can be provided for the antenna in the electronic device is increasingly limited, and is even less than 1 mm in some environments. Then, in the conventional antenna solution shown in FIG. 2, a frequency band such as a low frequency band cannot be covered well, and therefore, the wireless communication function of the electronic device cannot be supported well.

To provide good radiation performance in a limited space, embodiments of this application provide a terminal antenna solution, where an excitation mode different from a conventional excitation mode is used to perform radiation by exciting a uniform electric field between a radiator and a reference ground. In this way, radiation performance is improved in a small space (such as a small clearance). In the conventional solution, impact of a clearance on radiation performance such as a bandwidth and efficiency at a low frequency is especially significant. Therefore, the antenna solution provided in embodiments of this application can achieve a better effect when applied to low-frequency coverage.

The solution provided in embodiments of this application is described below in detail with reference to accompanying drawings.

The antenna solution (or referred to as a terminal antenna) provided in embodiments of this application may be used in an electronic device of a user, to support a wireless communication function of the electronic device. For example, the electronic device may be a portable mobile device such as a mobile phone, a tablet computer, a personal digital assistant (personal digital assistant, PDA), an augmented reality (augmented reality, AR)/virtual reality (virtual reality, VR) device, or a media player, or may be a wearable electronic device such as a smartwatch. A specific form of the device is not particularly limited in embodiments of this application.

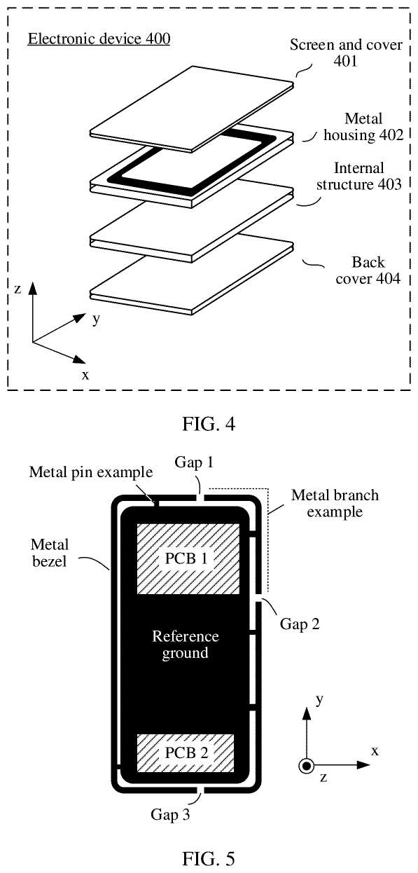

FIG. 4 is a diagram of a structure of an electronic device 400 according to an embodiment of this application. As shown in FIG. 4, in the electronic device 400 provided in this embodiment of this application, a screen and cover 401, a metal housing 402, an internal structure 403, and a back cover 404 may be arranged in sequence from top to bottom along a z-axis.

The screen and cover 401 may be configured to implement a display function of the electronic device 400. The metal housing 402 may serve as a body frame of the electronic device 400 to provide rigid support for the electronic device 400. The internal structure 403 may include electronic components and mechanical components for implementing various functions of the electronic device 400. For example, the internal structure 403 may include a shield, a screw, and a stiffener. The back cover 404 may be a back appearance surface of the electronic device 400. The back cover 404 may be made of a glass material, a ceramic material, plastic, or the like in different implementations.

The antenna solution provided in embodiments of this application can be used in the electronic device 400 shown in FIG. 4, to support a wireless communication function of the electronic device 400. In some embodiments, an antenna in the antenna solution may be arranged on the metal housing 402 of the electronic device 400. In some other embodiments, the antenna in the antenna solution may be arranged on the back cover 404 of the electronic device 400, or the like.

In different implementations of embodiments of this application, specific implementations of the antenna may be different. For example, in some embodiments, the antenna may be implemented in combination with a metal bezel on the metal housing 402 shown in FIG. 4. In some other embodiments, the antenna solution may alternatively be implemented by using a flexible printed circuit (Flexible Printed Circuit, FPC), a metalframe diecasting for anodization (Metalframe Diecasting for Anodization, MDA), or the like. Alternatively, the antenna solution may be obtained by combining at least two of the foregoing implementations.

For example, the metal housing 402 has a metal bezel architecture. FIG. 5 is a composition diagram of the metal housing 402. In this example, a metal material, such as an aluminum alloy, may be used for the metal housing 402. As shown in FIG. 5, the metal housing 402 may be provided with a reference ground. The reference ground may be a metal material having a large area, and is configured to provide most rigid support and provide a zero potential reference for various electronic components. In the example shown in FIG. 5, a metal bezel may be further arranged around the reference ground. The metal bezel may be a complete closed metal annular bezel, or may be a metal bezel broken by one or more gaps, as shown in FIG. 5. For example, in the example of FIG. 5, a gap 1, a gap 2, and a gap 3 may be respectively arranged at different positions on the metal bezel. These gaps may break the metal bezel, to obtain independent metal branches. In some embodiments, some or all of these metal branches may be configured for use as radiation branches (or referred to as radiators) of the antenna, to implement structural reuse during antenna arrangement and reduce difficulty in antenna arrangement. When a metal branch is used as a radiation branch of the antenna, a position of a gap correspondingly arranged at one or both ends of the metal branch may be flexibly selected based on arrangement of the antenna.

In the example shown in FIG. 5, one or more metal pins may be further arranged on the metal bezel. In some examples, the metal pin may be provided with a screw hole to fasten another structural member by using a screw. In some other examples, the metal pin may be coupled to a feed point (also referred to as a feed), so that when a metal branch connected to the metal pin is used as a radiation branch of the antenna, the antenna is fed through the metal pin. In some other examples, the metal pin may be further coupled to another electronic component to implement a corresponding electrical connection function.

In the example of FIG. 5, a printed circuit board (printed circuit board, PCB) is arranged on the metal housing 402. A split-board design with a main board (main board) and a sub board (sub board) is used as an example. In some other examples, the main board and the sub board may alternatively be connected, such as an L-shaped PCB design. In some embodiments, the main board (such as a PCB1) may be configured to carry electronic components of various functions of the electronic device 400, such as a processor, a memory, and a radio frequency module. The sub board (such as a PCB2) may also be configured to carry electronic components, such as a universal serial bus (Universal Serial Bus, USB) interface and a related circuit, and a speak box (speak box). The USB interface may be a Micro-USB interface, a type-C interface, or the like. In some implementations, the sub board may be further configured to carry a radio frequency circuit corresponding to an antenna arranged on a bottom portion (that is, a y-axis negative direction part of the electronic device), and the like.

The electronic device 400 in the foregoing example is merely a possible composition. In some other embodiments of this application, the electronic device 400 may alternatively have another composition. For example, to implement the wireless communication function of the electronic device 400, the electronic device may be provided with a communication module. The communication module may include an antenna, a radio frequency module that exchanges signals with the antenna, and a processor that exchanges signals with the radio frequency module. Different modules may be connected through a radio frequency cable. The processor may include a modem (Modem), an application processor (AP), a baseband processor (BP), and the like. For example, the signal exchange between the radio frequency module and the antenna may be analog signal exchange. The signal between the radio frequency module and the processor may be an analog signal or a digital signal.

The antenna provided in embodiments of this application can be used in the electronic device having the composition shown in FIG. 4 or FIG. 5.

From a perspective of an operating principle of the antenna, the antenna solution provided in embodiments of this application may be an antenna solution having a magnetic flux loop radiation characteristic. In an example, in the antenna solution provided in embodiments of this application, a grounded inductor may be arranged on a part of the radiator away from the feed. Based on an energy storage characteristic of the inductor for magnetic energy, when a current on the radiator is reversed due to a change in a feed signal, a change in the current on the radiator is later than a change in a voltage, so that strong electric field distribution is obtained near the radiator at an end close to the feed. In addition, with reference to the description of the electric field distribution in FIG. 3, there is strong electric field distribution near the radiator at an end close to the grounded inductor. Therefore, electric field distribution in a region between the reference ground and the radiator between the feed and the grounded inductor tends to be uniform. The characteristic of radiation based on a uniform electric field is a radiation characteristic of a magnetic flux loop antenna. For related descriptions of the magnetic flux loop antenna, refer to Patent Application Nos. 2021110346044, 2021110333843, 202111034603X, and 2021110346114 filed on Sep. 3, 2021. Details are not described herein.

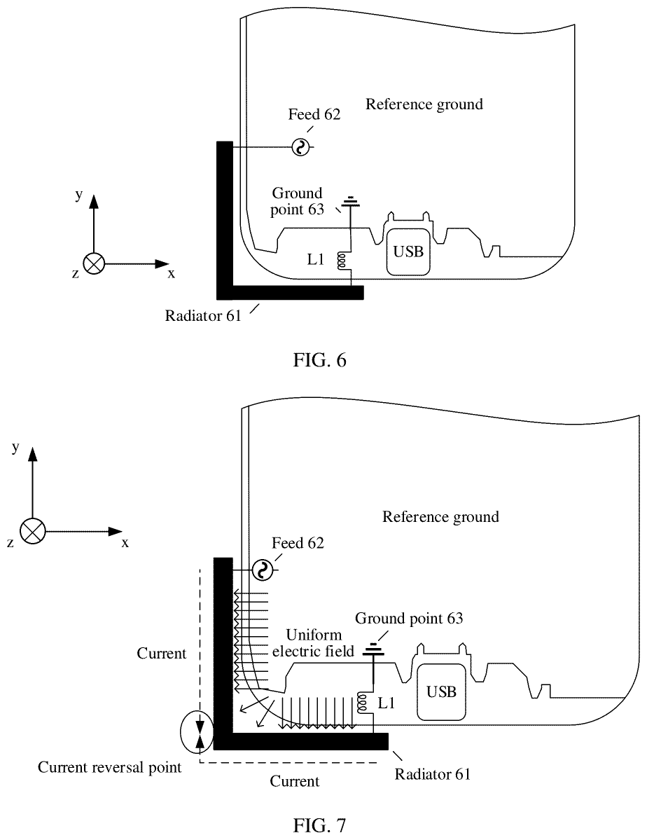

In an example, FIG. 6 is a diagram of an antenna solution according to an embodiment of this application. In this example, the metal bezel is reused for a radiator of the antenna. For a specific implementation, refer to the foregoing description of FIG. 5. It should be noted that, in the following examples, to describe the antenna more clearly, the antenna radiator is extended beyond an appearance surface of the electronic device for explanation. In an actual implementation process, when the metal bezel of the electronic device is reused for the antenna radiator, the antenna radiator is not arranged beyond the appearance surface of the electronic device, and therefore does not affect appearance of the electronic device.

As shown in FIG. 6, the antenna may be arranged at any corner of the electronic device. For example, the electronic device is a mobile phone. The radiator of the antenna may be arranged in an L shape. A corner of the L-shaped radiator corresponds to any one of four corners of the mobile phone. In the example of FIG. 6, the radiator (such as a radiator 61) of the antenna may be arranged at a lower left corner of the mobile phone.

The radiator 61 may be provided with a feed 62. The feed 62 may be configured for low-frequency feeding of the antenna. A ground point 63 may be arranged on a part of the radiator 61 away from the feed 62. An inductor L1 may be arranged between the ground point 63 and the radiator 61. For example, an operating frequency band covers a low frequency band. A value of the inductor L1 may be included within a range of [5 nH, 47 nH]. The part of the radiator 61 away from the feed may means that a length of the radiator 61 between the feed 62 and the inductor L1 meets the following limitation: being less than ¼ of a wavelength of the operating frequency band, and greater than ⅛ of the wavelength of the operating frequency band. During wavelength calculation, dielectric constants of different antenna radiators may be considered for conversion. A specific radiator length between the feed 62 and the inductor L1 may be flexibly set with reference to an operating frequency band to be covered and the inductor L1.

The foregoing description is provided from a perspective of the length of the radiator 61 between the feed 62 and the inductor L1. From another perspective, as the radiator 61 of the antenna is distributed in an L shape, the feed 62 and the inductor L1 may be respectively located on two arms of the L-shaped structure. That is, the feed 62 and the inductor L1, or the feed 62 and the ground point 63 may be arranged around a corner of the electronic device.

The example in which the operating frequency band covers a low frequency band is still used. When the feed 62 is arranged on a side edge (for example, a y-direction side edge or a long edge) of the electronic device, a shortest distance from the feed 62 to a transverse edge (for example, an x-direction transverse edge or a short edge) of the electronic device may be set within a range of [0 mm, 30 mm]. For example, using the structure shown in FIG. 6 as an example, the antenna is arranged at a lower left corner of a rear view of the mobile phone. In this case, the shortest distance from the feed 62 to the transverse edge of the electronic device is a y-direction distance from the feed 62 to a bottom edge of the mobile phone. In this example, the y-direction distance from the feed 62 to the bottom edge may be set within a range of [5 mm, 30 mm].

It should be noted that, a specific implementation of a feeding form of the antenna solution provided in embodiments of this application may vary in different embodiments. Arrangement of the feed 62 is used as an example. A conductive spring plate may be arranged at the feed 62. One end of the conductive spring plate may be connected (for example, soldered or screwed) to a radio frequency cable on a PCB, and the other end of the conductive spring plate may be elastically connected to the radiator 61. In this way, an electrical connection between the radio frequency cable for transmitting a low-frequency radio frequency signal and the radiator 61 is implemented at the feed 62. In some other embodiments, the electrical connection may alternatively be implemented through an electrical connection component such as a metal pin, a conductive adhesive, a conductive foam, or a conductive screw. In different scenarios, there is a requirement on a transverse size of a component that is on the PCB and close to the feed 62 and that is electrically connected to the radiator 61, and a signal transmission line such as a radio frequency microstrip line may be arranged between the electrically connected component on the PCB and a radio frequency port. For such consideration, to obtain efficient feeding at the feed 62, in embodiments of this application, a distance between the feed 62 and a radio frequency port that is on the PCB and that is configured to transmit a feed signal may be set within a range of [0.5 mm, 8 mm].

In the foregoing examples, the solution provided in embodiments of this application is described from a structural perspective. Operation of the antenna solution is described below with reference to accompanying drawings.

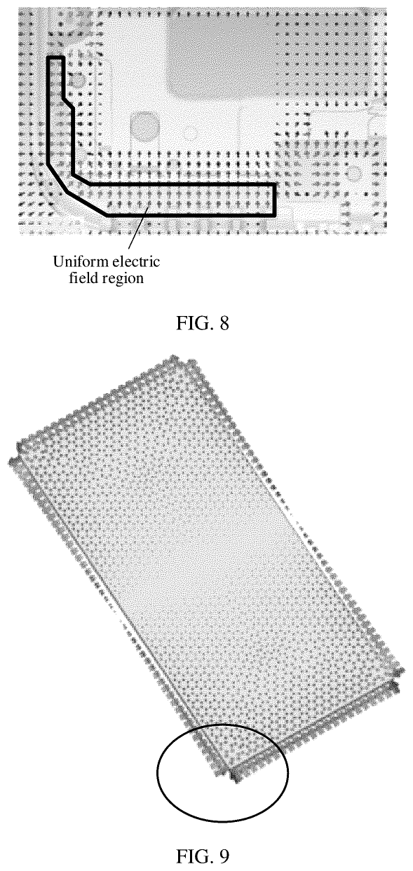

FIG. 7 shows electrical parameter distribution of an antenna having the structural composition shown in FIG. 6 during operation according to an embodiment of this application. Electric parameters shown therein may include a current and an electric field. As shown in FIG. 7, when the antenna operates, a uniformly distributed electric field may be formed near the radiator 61. The “near the radiator 61” may be understood as a region surrounded between the radiator 61 and the reference ground and between the feed 62 and the ground point 63 (or the inductor L1). In this way, the radiation characteristic of the magnetic flux loop antenna is implemented, that is, radiation is performed through the uniform electric field. With further reference to a diagram of actual simulation in FIG. 8, it can be seen that a uniform electric field may be distributed in a region near the radiator 61. The simulation result matches the radiation characteristic of the magnetic flux loop antenna in the foregoing description.

From a current perspective, as shown in FIG. 7, a current including a current reversal point may be further distributed on the antenna radiator 61. The current reversal point may be located on a radiator between the feed 62 and the ground point 63. In contrast, in the conventional antenna solution, with reference to the example in FIG. 3, there is no reversal point for the current distributed on the antenna radiator. In other words, in the conventional antenna solution, currents in a same direction are distributed on the radiator. This is a significant feature distinguishing the antenna solution provided in embodiments of this application from the conventional antenna during operation.

It should be noted that, In the foregoing examples of FIG. 6 to FIG. 8, the antenna may be arranged at the lower left corner of the rear view of the electronic device. In some other embodiments of this application, the antenna may alternatively be arranged at another position of the electronic device, for example, a lower right corner of the rear view, an upper left corner of the rear view, or an upper right corner of the rear view.

It may be understood that, the mechanism of arranging the feed on the long edge in this application may be determined based on floor eigenmode distribution of the electronic device. For example, FIG. 9 is a diagram of floor eigenmode distribution of the electronic device according to an embodiment of this application. The diagram may indicate distribution of floor electric field eigenmodes at different positions on the electronic device in a low frequency band. It can be seen that electric field strength is maximum at the four corners of the electronic device. In addition, an operation mechanism of the antenna solution provided in this application is radiation through a uniform electric field. Therefore, the feed when arranged near a corner of the electronic device can match the electric field distribution of the floor eigenmodes of the electronic device, thereby providing good radiation performance.

In some embodiments, the feed of the antenna may be arranged on a long-edge radiator corresponding to the corner. In this way, while matching the electric field distribution of the floor eigenmodes of the electronic device, the feed can excite a transverse current and an oblique current on a floor well, so that the floor of the electronic device can also participate in radiation of the antenna, to further improve radiation performance of the antenna.

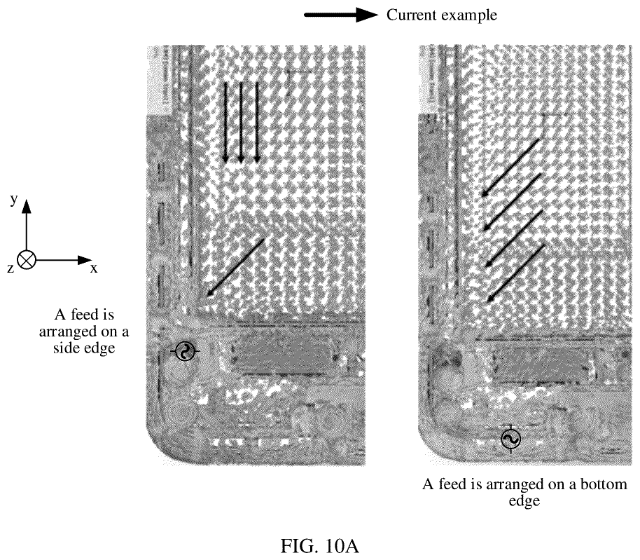

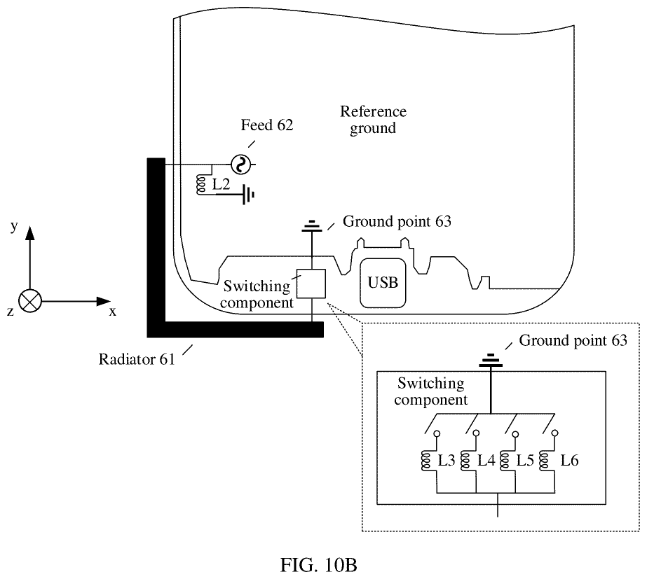

For example, as shown in FIG. 10A, when the feed is arranged on the bottom edge (that is, the short edge), a strong oblique current can be excited on the floor of the electronic device. When the oblique current is discomposed in a transverse direction and a longitudinal direction, a transverse current on the floor close to a position of the feed is strong, and a longitudinal current is relatively weak. Therefore, distribution of the transverse current and the longitudinal current is unbalanced. Correspondingly, when the feed is arranged on the side edge (that is, the long edge), a significant longitudinal current can be excited while a longitudinal current is excited. In this way, when the feed is arranged on the side edge, the transverse current and the longitudinal current are relatively balanced. Therefore, the solution of arranging the feed on the side edge so that a balanced transverse current and longitudinal current can be generated can improve radiation performance of the antenna.

In the foregoing solution, the antenna may radiate through a uniformly distributed electric field, to excite a resonance to cover a low frequency. In a specific implementation process, there are scenarios in which a plurality of low frequency bands need to be covered at different time. For example, at some moments, the antenna needs to cover the frequency band B28. At some other moments, the antenna needs to cover the frequency band B5. At some moments, the antenna needs to cover the frequency band B8. Then, based on the antenna solution provided in the foregoing description, an adjustable component, such as an adjustable switch or an adjustable inductor, may be arranged at L1, to adjust to corresponding inductance values when different low frequency bands need to be covered, so that a resonance frequency of the antenna is adjusted to cover the different low frequency bands. It should be noted that, in some implementations of this application, the low frequency band may further spread to a frequency lower than B28. For example, the low frequency band may include [500 MHz, 960 MHz]. Switching of another frequency band in the low frequency band is similar to switching of the foregoing B5/B8/B28. Details are not described herein again.

For example, FIG. 10B is a composition diagram of another antenna according to an embodiment of this application. With reference to the antenna structure shown in FIG. 6, in FIG. 10B, the grounded inductor L1 may be replaced with a switching component. The switching component may have at least two switching paths, and different switching paths may be provided with inductors with different inductance values. For example, in FIG. 10B, the switching unit includes four switching paths. In this case, the switching component may implement its function by using SP4T, 4SPST, or other switching switches. In this example, the four switching paths may be provided with L3, L4, L5, and L6 respectively. Inductance values of L3, L4, L5, and L6 are different from each other. Different inductance values may correspond to different low frequency bands. In this way, in case of needing to switch to a corresponding low frequency band, the switching component is controlled to switch to a corresponding path, so that different inductors are configured in different cases, to adjust a frequency band in low-frequency coverage.

In the example shown in FIG. 10B, a matching circuit may be further arranged between the feed 62 and the radiator 61. The matching circuit may be configured to adjust port matching for the antenna. For example, in some embodiments, the matching circuit may include a parallel inductor L2. L2 may be configured to cooperate with L1 or the switching component to implement a low frequency band switching function within a larger range. In an example, an inductance value range of L2 may be set less than 5 nH.

It should be noted that, in the example shown in FIG. 10B, the switching component is arranged at a position corresponding to L1 to implement low-frequency switching. In some other embodiments, the switching component may alternatively be arranged at a position corresponding to L2, or the switching component may be arranged at both L1 and L2, to implement the low-frequency switching function.

In the foregoing examples, an example in which the feed 62 is arranged on the long edge is used for description. It should be understood that the position of the feed 62 may be flexibly adjusted as required on the long edge. For example, with reference to FIG. 10C, the position of the feed 62 in the structure shown in FIG. 10B is adjusted. The feed 62 may be moved downward along the long edge, for example, moved to an end of the long edge, that is, the corner of the electronic device. Correspondingly, a position of the inductor L2 may not be changed. Then, in a structure after the feed 62 is moved, there is uniform electric field distribution between the feed 62 and the inductor L2 and between the feed 62 and the inductor L1 for radiation. In addition, because the feed 62 is arranged at the corner, a current reversal point is located at the corner. Correspondingly, a small magnetic flux loop antenna may be formed between the feed and L1. Similarly, a small magnetic flux loop antenna may also be formed between the feed and L2. Therefore, from a current distribution perspective, there may be a current reversal point distributed between the feed and L1, there may be a current reversal point at the feed, and there may be a current reversal point distributed between the feed and L2.

In some other embodiments, embodiments of this application further provide another antenna structure, so that when the antenna operates, a resonance (for example, referred to as a magnetic flux loop zero-order mode resonance) can be excited through a uniform electric field, and an additional resonance can be generated, to improve low-frequency radiation performance.

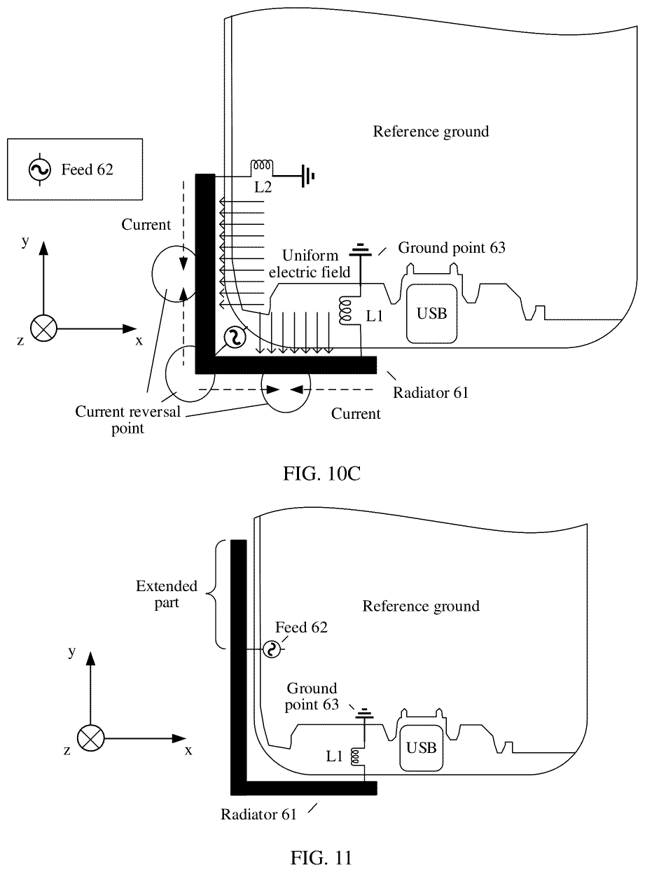

For example, with reference to FIG. 11, based on the structure shown in FIG. 6, the radiator 61 may be extended in the y-direction. In this way, the radiator 61 of the antenna may include a part between the feed 62 and the ground point 63, and an extended part. For example, the operating frequency band of the antenna covers a low frequency band. A length of the extended part (that is, a radiator from the feed 62 to an end away from the ground point 63) may be set within a range of [30 mm, 40 mm].

When the antenna shown in FIG. 11 operates, the antenna may obtain a uniformly distributed electric field through excitation in a region between the feed 62 and the ground point 63, and may further obtain an additional resonance based on radiation of the extended part. For example, the extended part may excite a resonance within a range of [1 GHz, 1.5 GHz] in the ¼ wavelength mode. An electric field direction corresponding to the extended part is the same as an electric field direction corresponding to a magnetic flux loop zero-order mode. Although the resonance does not necessarily fall within the low frequency band range, because the resonance is close to the low frequency band (for example, close to a high frequency side of the low frequency band), effects of expanding a bandwidth and improving efficiency can be achieved on a high frequency side of the magnetic flux loop zero-order mode resonance. In addition, in a non-free-space scenario, such as a hand hold scenario (that is, a hand phantom scenario) or a phone scenario (that is, a head-and-hand phantom scenario), due to bandwidth expansion, a loss caused by a hand phantom or a head-and-hand phantom to antenna performance can be significantly reduced.

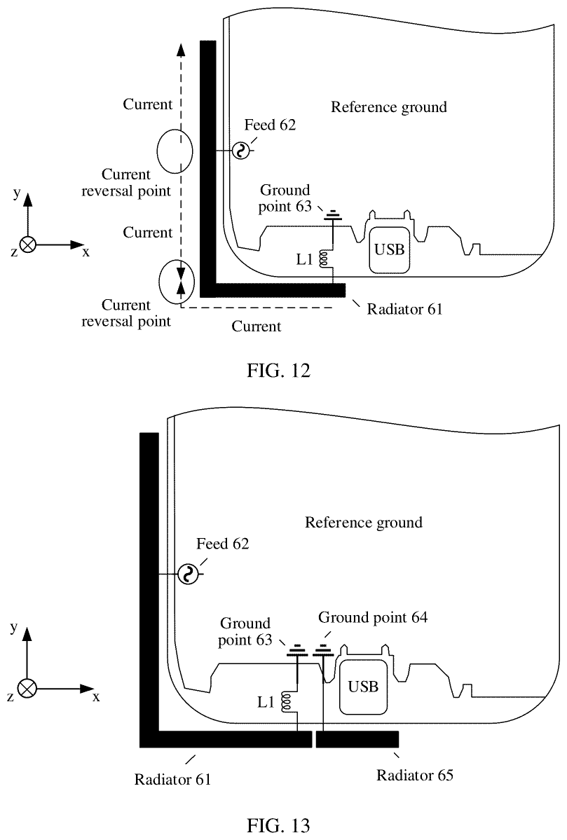

From the current distribution perspective, with reference to FIG. 12, when the antenna having the structure shown in FIG. 11 operates, a current reversal point is distributed between the feed 62 and the ground point 63. For the extended part, there is a large current point near the feed 62, and there is a small current point at an end of the extended part away from the feed. Therefore, there may be a current direction from the feed 62 to the end on the extended part. That is, the current direction on the extended part is opposite to a direction of a current near the feed 62 and directed to the ground point 63, thereby forming another current reversal point. In other words, with the extended part arranged, when the antenna operates, from a perspective of current distribution in the operating frequency band, the radiator 61 may include two current reversal points.

In the foregoing examples of FIG. 11 and FIG. 12, the radiator 61 is extended at the end close to the feed 62, so that an additional resonance is obtained, to cover a low frequency band together with the magnetic flux loop zero-order mode resonance. In some other embodiments of this application, based on the solution shown in FIG. 6 or FIG. 11, another structure may be further arranged close to the ground point 63, to obtain more resonances to expand low-frequency coverage.

For example, with reference to FIG. 13, arrangement is performed based on the solution shown in FIG. 11. A radiator 65 that is not connected to the radiator 61 may be arranged at an end of the radiator 61 close to the ground point 63. For example, the radiator 65 may be arranged on an outer side of the USB interface. The radiator 65 may be not connected to a USB interface related component (for example, a metal member of a USB body). An end of the radiator 65 may be arranged opposite to the end of the radiator 61 close to the ground point 63, and the two radiators are separated by a gap. In some embodiments, a width of the gap may be set within a range of [0.8 mm, 1.5 mm].

The radiator 65 may be further provided with a ground point 64. In different implementations, the ground point 64 may be arranged at an end of the radiator 65 close to the radiator 61, or may be arranged at an end of the radiator 65 away from the radiator 61. In this example, the ground point 64 is arranged at the end close to the radiator 61. In this way, based on a parasitic effect, when a current from the feed 61 is distributed on the radiator 61 (that is, when the antenna operates), the radiator 65 may perform energy coupling through the gap between the radiator 65 and the radiator 61, to obtain energy on the radiator 65 and excite a corresponding parasitic resonance. In this example, the radiator 65 may generate a parasitic resonance on a low frequency side of the low frequency band, thereby obtaining an additional resonance on a low frequency side of the magnetic flux loop zero-order mode resonance, to expand a bandwidth and improve efficiency on the low frequency side in the antenna solution provided in embodiments of this application. In addition, similar to the bandwidth expansion effect of the extended part in the solution shown in FIG. 11, the radiator 65 can also be arranged to reduce the loss caused by a hand phantom or a head-and-hand phantom to antenna performance. For example, the operating frequency band of the antenna covers a low frequency band. A length of the radiator 65 may be set within a range of [13 mm, 20 mm].

It should be understood that the foregoing antenna solutions provided in FIG. 6 to FIG. 13 can provide better radiation performance at the low frequency than the conventional antenna (such as the antenna solution shown in FIG. 2). In addition, due to a wide low-frequency bandwidth, good hand phantom and head-and-hand phantom performance can be obtained. The following uses the structure shown in FIG. 13 as an example to describe the foregoing beneficial effects by using simulation results.

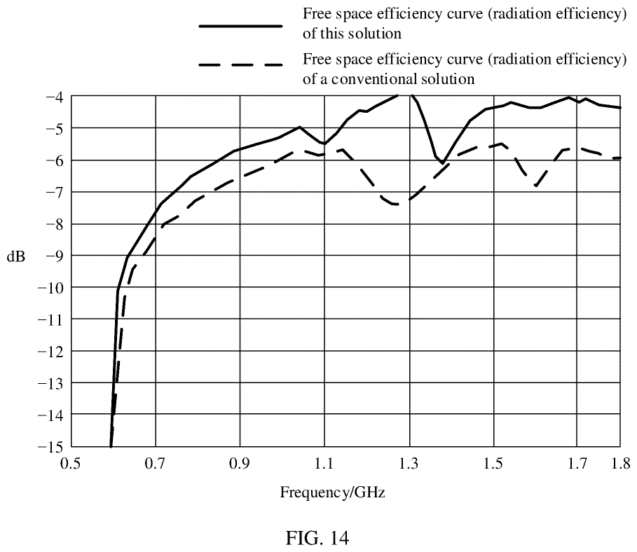

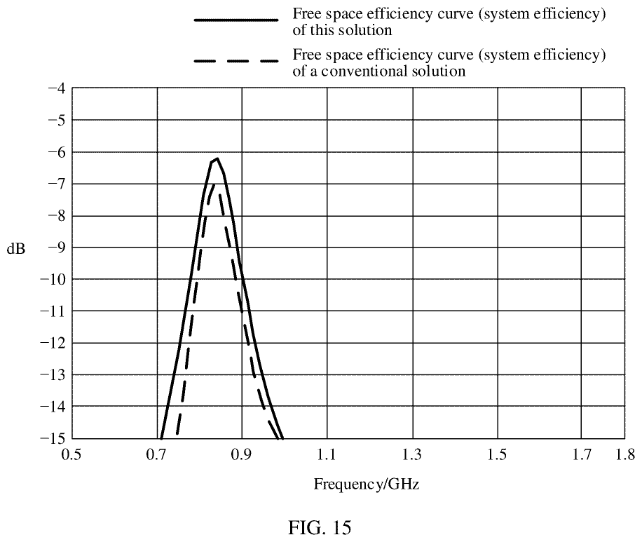

For example, FIG. 14 is a diagram of a radiation efficiency curve of the structure shown in FIG. 13 during operation. The radiation efficiency may be an indicator for indicating antenna efficiency. The radiation efficiency may indicate maximum efficiency that a current antenna system can achieve at each frequency with port matching in a full frequency band. Correspondingly, indicators of the antenna efficiency may further include system efficiency. Different from the radiation efficiency, the system efficiency may be efficiency that the antenna can achieve with current port matching. For ease of comparison, radiation efficiency of the conventional antenna solution (such as the antenna solution shown in FIG. 2) is also shown in FIG. 14 for comparison. As shown in FIG. 14, the antenna solution provided in embodiments of this application has significantly higher radiation efficiency in the low frequency band than the conventional solution. For example, near 900 MHz, radiation efficiency of the antenna solution provided in embodiments of this application that has the structure shown in FIG. 13 is 1 dB higher than that of the conventional antenna solution. FIG. 15 is a diagram of a system efficiency curve of the structure shown in FIG. 13 during operation. System efficiency of the conventional antenna solution (such as the antenna solution shown in FIG. 2) is also shown in FIG. 15 for comparison. It can be seen that in a full frequency band of B5, the antenna solution provided in this application has higher system efficiency than the conventional antenna solution. Near 850 MHz with best port matching, system efficiency optimization approaches 1 dB. That is, as illustrated by comparison in FIG. 14 and FIG. 15, in a free space, the antenna solution provided in embodiments of this application can provide a better bandwidth and efficiency than the conventional antenna.

The following describes, with reference to simulation results, hand phantom and head-and-hand phantom performance of the antenna solution provided in embodiments of this application. The example in which the antenna has the structure shown in FIG. 13 is still used.

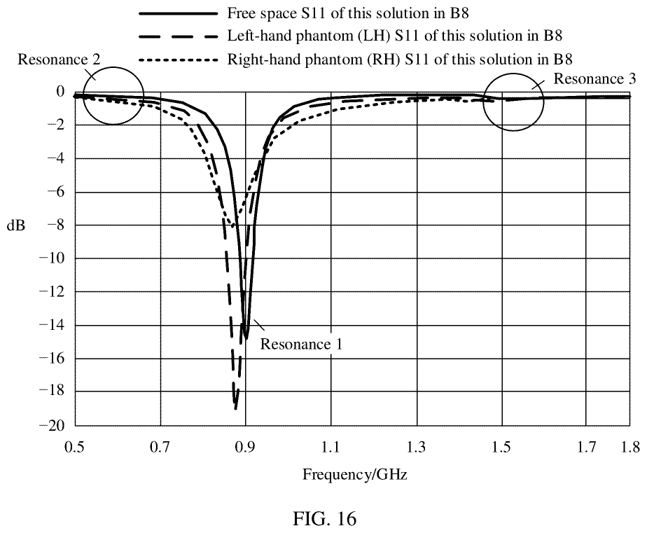

For example, FIG. 16 is a diagram of return loss (S11) curves in hand phantom scenarios when the antenna solution provided in embodiments of this application covers B8. As shown in FIG. 16, when the antenna is configured to cover B8, using S11 of a free space as an example, the antenna can generate a plurality of resonances. For example, the plurality of resonances may include a resonance 1. The resonance 1 may correspond to the magnetic flux loop zero-order mode resonance in the foregoing description. The plurality of resonances may further include a resonance 2. The resonance 2 may correspond to the parasitic resonance generated by the radiator 65 in the foregoing description. The plurality of resonances may further include a resonance 3. The resonance 3 may correspond to the ¼ mode resonance generated by the extended part in the foregoing description. From S11 of the free space, it can be seen that a deepest point exceeds −14 dB. Therefore, good radiation performance can be achieved in the free space. From S11 of hand phantoms, S11 of each of a left-hand phantom and a right-hand phantom has a specific frequency offset relative to the free space, which may be caused by the hand phantom close to the antenna absorbing a specific amount of radiation of the antenna. As shown in FIG. 16, a deepest point of S11 of the left-hand phantom exceeds −18 dB, and a deepest point of S11 of the right-hand phantom reaches −8 dB. Therefore, radiation performance in the two hand phantom scenarios can be ensured. In addition, from a frequency offset perspective, relative to the free space, neither of frequency offsets of the left-hand phantom and the right-hand phantom exceeds 50 MHz. That is, according to the antenna solution provided in embodiments of this application, in the hand phantom scenarios, the hand phantoms do not cause excessively large frequency offsets on the antenna, which result in a failure to effectively cover the operating frequency band. It may be understood that, through structural arrangement for exciting the resonance 2 and the resonance 3 in the structure shown in FIG. 13, a bandwidth of a main resonance (for example, the resonance 1, that is, the magnetic flux loop zero-order mode resonance) is expanded, so that beneficial effects of small offsets of the hand phantoms and good S11 of the hand phantoms are achieved.

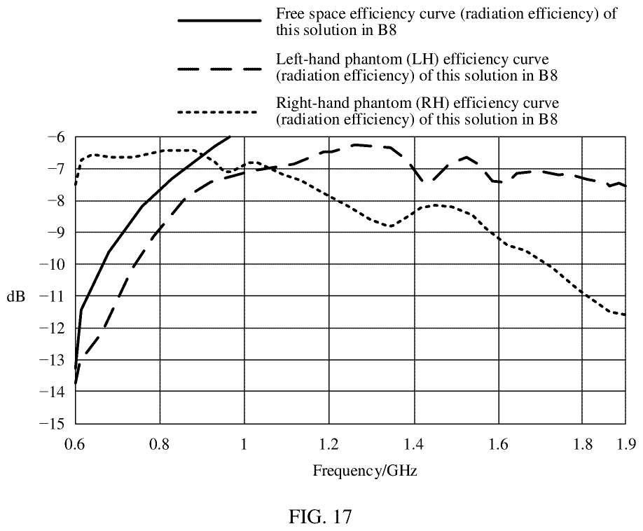

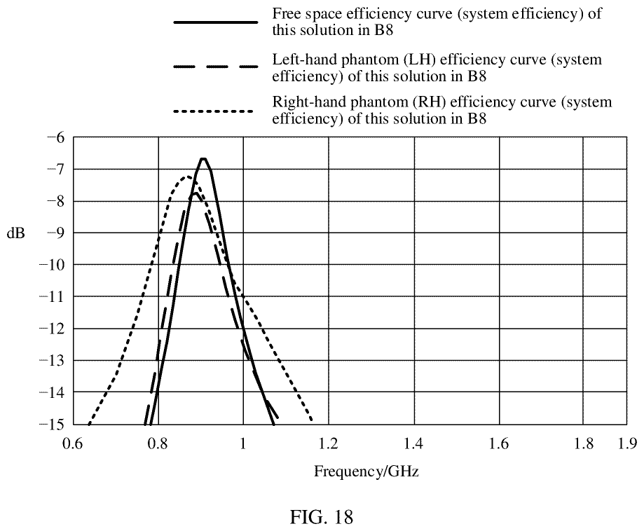

The following continues to describe the radiation performance of the antenna in combination with efficiency simulation. FIG. 17 is a diagram of radiation efficiency curves in hand phantom scenarios when the antenna solution provided in embodiments of this application covers B8. It can be seen that in the free space and right-hand phantom scenarios, the radiation efficiency exceeds or approaches −7 dB in the frequency band B8. In the left-hand phantom scenario, the radiation efficiency in the frequency band B8 is above −7.5 dB. FIG. 18 is a diagram of system efficiency curves in test scenarios when the antenna solution provided in embodiments of this application covers B8. Corresponding to the radiation efficiency, in the free space and right-hand phantom scenarios, a radiation efficiency peak exceeds or approaches −7 dB. In the left-hand phantom scenario, a radiation efficiency peak is above −8 dB. Considering that the simulation result comes from whole-machine simulation, a difference between the simulation result and an actual measurement result is very limited. Therefore, when the radiation efficiency of the hand phantoms exceeds −7.5 dB and the system efficiency exceeds −8 dB, it is sufficient to prove that the antenna solution provided in embodiments of this application can provide good radiation performance in the frequency band B8.

FIG. 16 to FIG. 18 are described above by using an example in which radiation is performed when the antenna solution provided in embodiments of this application operates in B8. Through value switching of the grounded inductor, the operating frequency band of the antenna can be further adjusted to cover another frequency band in the low frequency band, for example, cover B5 or B28. It should be understood that the antenna provided in embodiments of this application can also provide good radiation performance when covering other frequency bands. For example, the operating frequency band of the antenna covers B5.

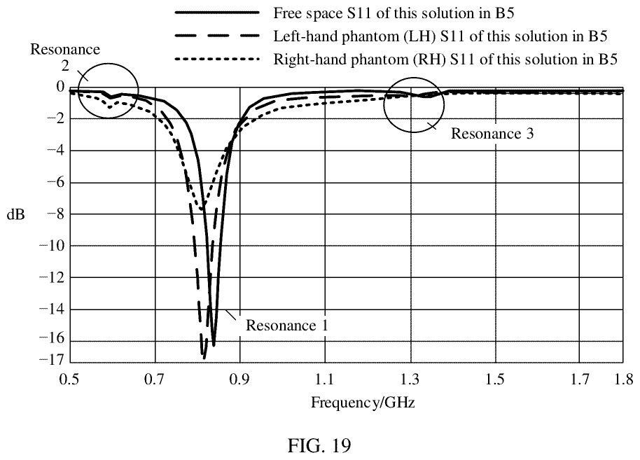

FIG. 19 is a diagram of return loss (S11) curves in hand phantom scenarios when the antenna solution provided in embodiments of this application covers B5. As shown in FIG. 19, when the antenna is configured to cover B5, using S11 of a free space as an example, the antenna can generate a plurality of resonances. For example, the plurality of resonances may include a resonance 1. The resonance 1 may correspond to the magnetic flux loop zero-order mode resonance in the foregoing description. The plurality of resonances may further include a resonance 2. The resonance 2 may correspond to the parasitic resonance generated by the radiator 65 in the foregoing description. The plurality of resonances may further include a resonance 3. The resonance 3 may correspond to the ¼ mode resonance generated by the extended part in the foregoing description. From S11 of the free space, it can be seen that a deepest point exceeds −16 dB. Therefore, good radiation performance can be achieved in the free space. From S11 of hand phantoms, S11 of each of a left-hand phantom and a right-hand phantom has a specific frequency offset relative to the free space, which may be caused by the hand phantom close to the antenna absorbing a specific amount of radiation of the antenna. As shown in FIG. 19, a deepest point of S11 of the left-hand phantom exceeds −16 dB, and a deepest point of S11 of the right-hand phantom approaches −8 dB. Therefore, radiation performance in the two hand phantom scenarios can be ensured. In addition, from a perspective of a frequency offset relative to the free space, neither of frequency offsets of the left-hand phantom and the right-hand phantom exceeds 50 MHz. That is, according to the antenna solution provided in embodiments of this application, in the hand phantom scenarios, the hand phantoms do not cause excessively large frequency offsets on the antenna, which result in a failure to effectively cover the operating frequency band. It may be understood that, through structural arrangement for exciting the resonance 2 and the resonance 3 in the structure shown in FIG. 13, a bandwidth of a main resonance (for example, the resonance 1, that is, the magnetic flux loop zero-order mode resonance) is expanded, so that beneficial effects of small offsets of the hand phantoms and good S11 of the hand phantoms are achieved. With reference to the descriptions of the B8 scenario in FIG. 16 and FIG. 17, it can be seen that a hand phantom test situation in the B5 scenario is similar to that in B8. That is, the antenna provided in embodiments of this application can provide good radiation performance in the free space and hand phantom scenarios.

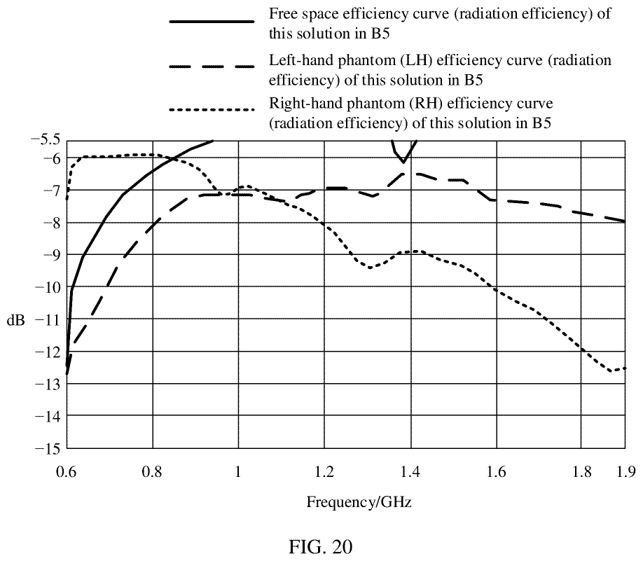

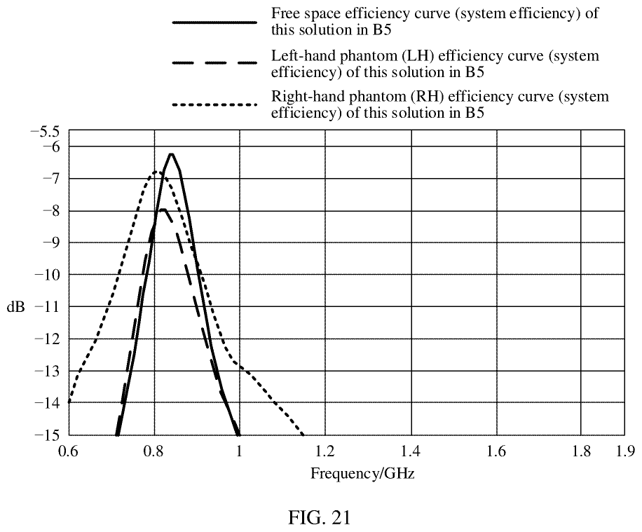

The following continues to describe the radiation performance of the antenna in combination with efficiency simulation. FIG. 20 is a diagram of radiation efficiency curves in hand phantom scenarios when the antenna solution provided in embodiments of this application covers B5. It can be seen that in the free space and right-hand phantom scenarios, the radiation efficiency exceeds or approaches −6.5 dB in the frequency band B5. In the left-hand phantom scenario, the radiation efficiency in the frequency band B5 approaches −7 dB. FIG. 21 is a diagram of system efficiency curves in test scenarios when the antenna solution provided in embodiments of this application covers B5. Corresponding to the radiation efficiency, in the free space and right-hand phantom scenarios, a radiation efficiency peak exceeds −7 dB. In the left-hand phantom scenario, a radiation efficiency peak reaches −8 dB. Considering that the simulation result comes from whole-machine simulation, a difference between the simulation result and an actual measurement result is very limited. Therefore, when the radiation efficiency of the hand phantoms exceeds −7 dB and the system efficiency exceeds −8 dB, it is sufficient to prove that the antenna solution provided in embodiments of this application can provide good radiation performance in the frequency band B5. That is, similar to the B8 coverage scenario, the antenna solution provided in embodiments of this application can also provide good radiation performance when used to cover the frequency band B5.

By analogy, good free space and hand phantom radiation performance can also be provided in the frequency band B28. Details are not described herein again.

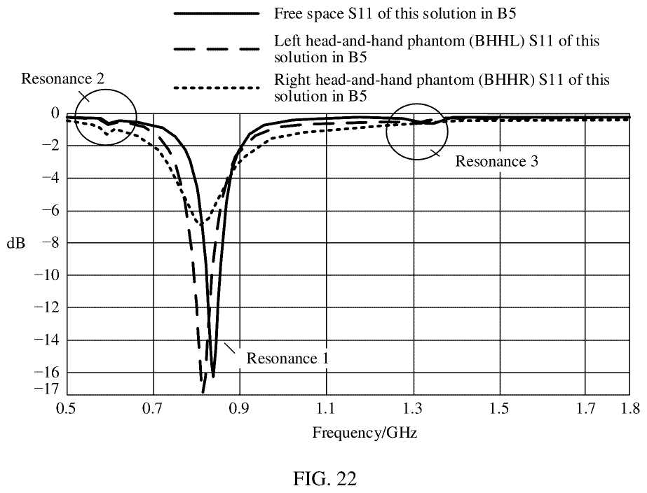

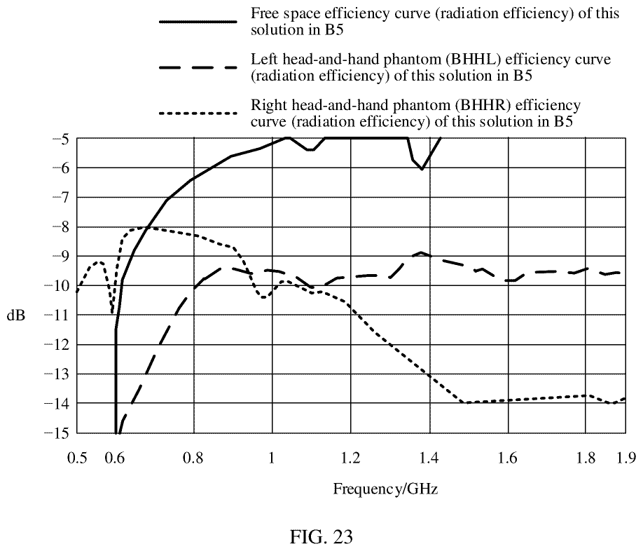

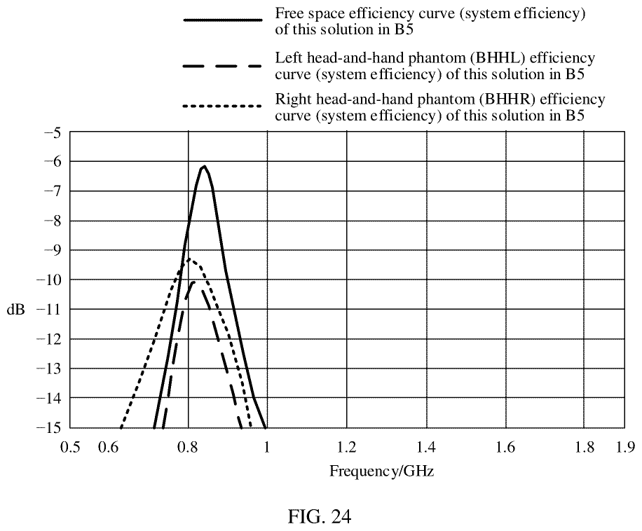

The following describes, with reference to simulation results, radiation of the antenna solution provided in embodiments of this application in head-and-hand phantom scenarios. In this example, the operating frequency band of the antenna covers B5. FIG. 22 shows comparison between S11 of the antenna solution provided in embodiments of this application in free space, left head-and-hand phantom, and right head-and-hand phantom scenarios. With reference to the diagram of hand phantom simulation in the frequency band B5 in FIG. 19, head-and-hand phantom simulation results shown in FIG. 22 are similar to the hand phantom simulation situation shown in FIG. 19. That is, from a perspective of S11, a head phantom does not bring significant impact. FIG. 23 shows comparison between radiation efficiency of the antenna solution provided in embodiments of this application in free space, left head-and-hand phantom, and right head-and-hand phantom scenarios. For the left head-and-hand phantom, the radiation efficiency in the frequency band B5 exceeds or approaches-10 dB, and a head-and-hand amplitude reduction is about 2 dB to 3 dB. For the right head-and-hand phantom, the radiation efficiency in the frequency band B5 exceeds −9 dB, and a head-and-hand amplitude reduction is about 3.5 dB. FIG. 24 shows comparison between system efficiency of the antenna solution provided in embodiments of this application in free space, left head-and-hand phantom, and right head-and-hand phantom scenarios. For the left head-and-hand phantom, a system efficiency peak in the frequency band B5 approaches −10 dB, and a head-and-hand amplitude reduction of the efficiency peak is about 4 dB. For the right head-and-hand phantom, a system efficiency peak in the frequency band B5 approaches −9 dB, and a head-to-hand amplitude reduction of the efficiency peak is about 3 dB. It should be understood that, when current low-frequency head-and-hand amplitude reduction is generally greater than 6 dB, according to the antenna solution provided in embodiments of this application, the amplitude reduction is controlled to fall within 4 dB in the head-and-hand phantom scenarios. Therefore, performance in the free space can be ensured, and good head-and-hand phantom radiation performance can also be provided.

From the foregoing description, a person skilled in the art should comprehensively understand the antenna solution provided in embodiments of this application. This solution can implement the radiation characteristic of the magnetic flux loop antenna through electric field radiation, and can provide good radiation performance in the low frequency band in the free space, hand phantom, and head-and-hand phantom scenarios.

The foregoing antenna solutions provided in FIG. 6 to FIG. 24 are described by using an example in which a low frequency band is covered. In some other embodiments of this application, the antenna solution may be further used to additionally cover another frequency band of the primary frequency, or additionally cover another frequency band, such as a Wi-Fi, BT, or 5G frequency band. Beneficial effects that can be provided are similar, and details are not described herein again.

Based on the foregoing antenna solutions provided in FIG. 6 to FIG. 24, for example, the antenna is used in a feed-off scenario for low-frequency coverage. An intermediate/high frequency feed and a corresponding antenna part may be further arranged in the electronic device, so that the split-feed antenna solution can cover the full frequency band of the primary frequency.

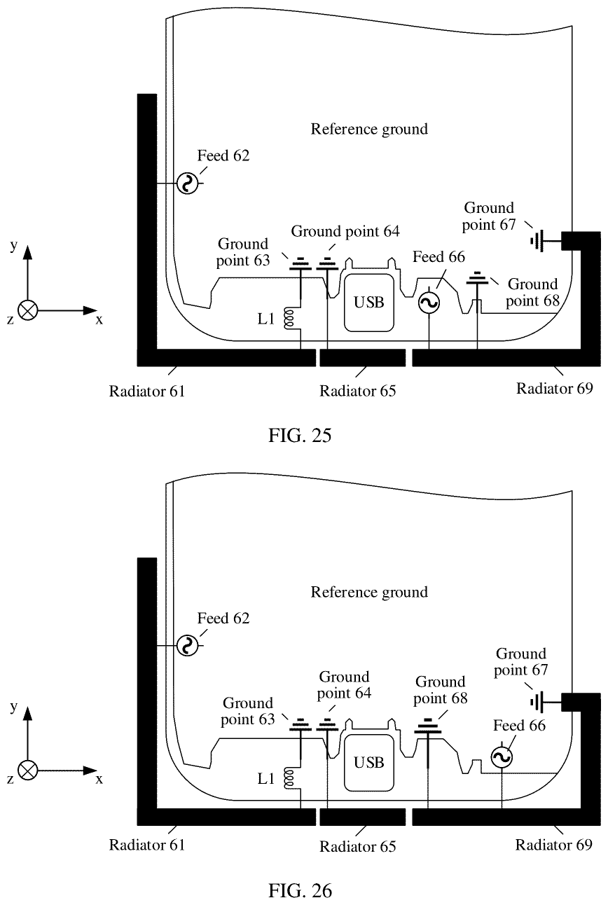

For example, FIG. 25 shows a split-feed antenna solution according to an embodiment of this application. The antenna may be configured to cover the primary frequency band. A feed 62, a radiator 61, a ground point 63, an inductor L1, a radiator 65, and a ground point 64 may be arranged to constitute a low-frequency radiation part to cover a low frequency band. For specific arrangement of the low-frequency radiation part, refer to the example in the foregoing description. Details are not described herein again. As shown in FIG. 25, the split-feed antenna solution may further include an intermediate/high-frequency radiation part. The intermediate/high-frequency radiation part may be arranged at the lower right corner of the rear view of the electronic device. The intermediate/high-frequency radiation part may include a feed 66 for providing an intermediate/high-frequency feed signal. The feed 66 may be arranged on a radiator 69. In some embodiments, when the low-frequency radiation part is arranged at the lower left corner of the rear view of the electronic device, the radiator 69 may be arranged in an L-shaped structure at the lower right corner of the rear view of the electronic device. The feed 66 may be arranged at an end of the radiator 69 close to the USB (or close to the low-frequency radiation part). In some embodiments, a matching network corresponding to the feed 66 may be provided with a series capacitor, to excite a corresponding left-hand mode. A ground point 67 may be arranged at an end of the radiator 69 away from the feed 66. In the example shown in FIG. 25, another ground point, such as a ground point 68, may be further arranged at a position other than the two ends of the radiator 69. The ground point 68 may provide an additional return path to the ground, so that the antenna can excite a resonance at a higher frequency. It should be noted that, in some implementations, an inductor component, an adjustable component, or a switching component may be connected between the radiator and the ground point 68 and/or the ground point 67 for switching between different high-frequency modes. Certainly, in some scenarios in which a high-frequency coverage bandwidth is narrow, the ground point 67 and/or the ground point 68 may alternatively be selectively arranged, that is, the ground point 67 and/or the ground point 68 may not be arranged.

Embodiments of this application further provide a split-feed antenna solution, as shown in FIG. 26. In this example, with reference to the example of FIG. 25, a low-frequency radiation part is similar to that in the example of FIG. 25, and a high-frequency radiation part has a difference in that positions of the ground point 68 and the feed 66 may be different. For example, the ground point 68 may be arranged at an end of the radiator 69 different from that of the ground point 67, that is, the end close to the low-frequency radiation part. Correspondingly, the feed 66 may be arranged on the radiator 69 at a position other than the two ends. Similar to the solution in FIG. 25, in some embodiments, the ground point 67 and/or the ground point 68 shown in FIG. 26 may also be selectively arranged.

When the intermediate/high-frequency radiation part operates, the feed 66 may feed an intermediate/high-frequency signal. The intermediate/high-frequency signal may include [1400 MHZ, 2700 MHz]. In the split-feed antenna solutions shown in FIG. 25 or FIG. 26, the intermediate/high-frequency radiation part may be excited at an intermediate frequency and a high frequency respectively to obtain at least two resonances. For example, in the intermediate frequency band, excited resonances may include a left-hand mode resonance formed on the radiator 69, and a corresponding multiplied-frequency resonance excited by the radiator 61 by using an intermediate frequency signal obtained through coupling to the radiator 65. In the high frequency band, excited resonances may include a resonance corresponding to a left-hand mode (or an IFA mode) and distributed on a radiator between the radiator 69 and the ground point 68, and a parasitic mode resonance excited by the radiator 65 through a parasitic effect. In some embodiments, an inductor may be connected in series between the ground point 64 and the radiator 65 to adjust an electrical length of the parasitic mode. For example, a value of the series inductor may be less than 5 nH.

For arrangement of the left-hand mode and a related structure, refer to CN201380008276.8 and CN201410109571.9. Details are not described herein.

It should be understood that in the split-feed antenna solution in FIG. 25 or FIG. 26, the arrangement of the high-frequency radiation part is merely an example. In another structure or scenario, the high-frequency radiation part may alternatively implement intermediate/high-frequency coverage by using another antenna structure. Because the low-frequency radiation part uses the antenna solution provided in embodiments of this application, and the low-frequency radiation part is independent of the high-frequency radiation part, regardless of the arrangement of the high-frequency radiation part, radiation performance that the split-feed antenna solution can provide at the low frequency can corresponds to the beneficial effects in the foregoing description respectively.

Although this application is described with reference to specific features and embodiments thereof, it is clear that various modifications and combinations may be made to this application without departing from the spirit and scope of this application. Correspondingly, this specification and the accompanying drawings are merely example descriptions of this application defined by the accompanying claims, and are considered to cover any or all modifications, variations, combinations, or equivalents within the scope of this application. It is clear that a person skilled in the art can make various modifications and variations to this application without departing from the spirit and scope of this application. This application is intended to cover these modifications and variations of this application provided that they fall within the scope of protection defined by the following claims and their equivalent technologies.

1. A terminal antenna, wherein the terminal antenna is arranged in an electronic device, the terminal antenna comprises a first radiator, the first radiator is provided with a first feed and a first ground point, and the first ground point is arranged at an end of the first radiator; and
the first ground point is connected to the first radiator through a first inductor, and a value of the first inductor is comprised within a range of [5 nH, 47 nH];
a length of a first part is greater than ⅛ of a wavelength of an operating frequency band and less than ¼ of the wavelength of the operating frequency band, and the operating frequency band is an operating frequency band of the terminal antenna, the first part is a radiator that is on the first radiator and that is between the first feed and the first ground point.

2. The terminal antenna according to claim 1, wherein a second inductor is arranged between the first feed and the first radiator, one end of the second inductor is connected to the first feed and the first radiator, the other end of the second inductor is grounded, and the second inductor is less than 5 nH; and
the first inductor and/or the second inductor are/is configured to adjust a resonance frequency of the terminal antenna.

3. The terminal antenna according to claim 1, wherein the first radiator is arranged in an L-shaped structure at any corner of the electronic device, the L-shaped structure comprises a first arm and a second arm, and the first arm is perpendicular to the second arm; and
the first feed is arranged on the first arm, and the first ground point is arranged on the second arm.

4. The terminal antenna according to claim 3, wherein a straight line on which the first arm is located is parallel to a long edge of the electronic device.

5. The terminal antenna according to claim 4, wherein a distance from the first feed to the second arm is comprised within a range of [0 mm, 30 mm].

6. The terminal antenna according to claim 1, wherein
when the terminal antenna operates, a uniform electric field is distributed between the first radiator and a reference ground; and
a current reversal point is distributed on the first part of the first radiator.

7. (canceled)

8. The terminal antenna according to claim 6, wherein the first radiator further comprises a second part, the second part is connected to the first part at the first feed, and an end of the second part away from the first feed is suspended.

9. The terminal antenna according to claim 8, wherein a length of the second part is comprised within a range of [30 mm, 40 mm]; and
when the terminal antenna operates, a ¼ wavelength mode is excited on the second part, and a direction of an electric field between the second part and the reference ground is the same as a direction of an electric field between the first arm of the first part and the reference ground.

10. The terminal antenna according to claim 1, wherein the terminal antenna further comprises a second radiator, the second radiator is not connected to the first radiator, and an end of the second radiator is arranged opposite to the end of the first radiator at which the first ground point is arranged; and
the second radiator is provided with a second ground point, the second ground point is arranged at an end of the second radiator close to the first radiator, and the other end of the second radiator is arranged suspended.

11. The terminal antenna according to claim 10, wherein a length of the second radiator is comprised within a range of [13 mm, 20 mm]; and
when the terminal antenna operates, a resonance frequency of a parasitic mode excited on the second radiator is lower than the operating frequency band of the terminal antenna.

12. The terminal antenna according to claim 10, wherein the second radiator is arranged on an outer side of a USB interface of the electronic device, and the second radiator is not connected to a body of the USB interface.

13. The terminal antenna according to claim 1, wherein the first feed is configured to feed a low-frequency signal to the first radiator, and a frequency of the low-frequency signal is comprised within a range of [500 MHz, 960 MHz].

14. A split-feed antenna system, wherein the split-feed antenna system comprises a first antenna and a second antenna, and the first antenna is the terminal antenna according to claim 1;
the second antenna comprises a third radiator, the third radiator is arranged in an L shape at a corner of the electronic device, a corner at which the third radiator is located is adjacent to the corner at which the first antenna is located, the third radiator is not connected to the radiator of the first antenna, and an end of the third radiator is coupled to an end of the radiator of the first antenna through a gap; and
the third radiator is provided with a second feed, the second feed is configured to feed an intermediate/high-frequency signal to the second antenna, and a frequency of the intermediate/high-frequency signal is comprised within a range of [1400 MHZ, 2700 MHz].

15. The split-feed antenna system according to claim 14, wherein the third radiator is further provided with a third ground point, and the third ground point and the second feed are arranged on two arms of an L-shaped structure corresponding to the third radiator.

16. An electronic device, wherein the electronic device is provided with the terminal antenna according to claim 1; and when the electronic device transmits or receives a low-frequency signal, the low-frequency signal is transmitted or received through the terminal antenna.

17. (canceled)

18. The terminal antenna according to claim 2, wherein the first radiator is arranged in an L-shaped structure at any corner of the electronic device, the L-shaped structure comprises a first arm and a second arm, and the first arm is perpendicular to the second arm; and
the first feed is arranged on the first arm, and the first ground point is arranged on the second arm.

19. The terminal antenna according to claim 2, wherein
when the terminal antenna operates, a uniform electric field is distributed between the first radiator and a reference ground; and
a current reversal point is distributed on the first part of the first radiator.

20. The terminal antenna according to claim 6, wherein the first radiator further comprises a second part, the second part is connected to the first part at the first feed, and an end of the second part away from the first feed is suspended.

21. The terminal antenna according to claim 9, wherein the terminal antenna further comprises a second radiator, the second radiator is not connected to the first radiator, and an end of the second radiator is arranged opposite to the end of the first radiator at which the first ground point is arranged; and
the second radiator is provided with a second ground point, the second ground point is arranged at an end of the second radiator close to the first radiator, and the other end of the second radiator is arranged suspended.

22. The terminal antenna according to claim 11, wherein the second radiator is arranged on an outer side of a USB interface of the electronic device, and the second radiator is not connected to a body of the USB interface.
